(19) United States
(12) Patent Application Publication
(10) Pub. No.: US 2026/0270800 A1
(43) Pub. Date: Sep. 10, 2026

(54) SYSTEMS AND METHODS FOR MANAGING MOBILITY OF MULTICAST UEs IN A WIRELESS NETWORK

(71) Applicant: Samsung Electronics Co., Ltd., Suwon-si, Gyeonggi-do (KR)

(72) Inventors: Vinay Kumar SHRIVASTAVA, Bangalore (IN); Sangkyu BAEK, Suwon-si (KR)

(21) Appl. No.: 18/871,693

(22) PCT Filed: Jul. 20, 2023
(86) PCT No.: PCT/KR2023/010457

§ 371 Date: Dec. 4, 2024

(30) Foreign Application Priority Data
Jul. 21, 2022 (IN) 202241041899
Jun. 23, 2023 (IN) 202241041899

(51) Int. Cl. H04W 36/00; H04W 4/06; H04W 48/20; H04W 76/27

(52) U.S. Cl. CPC H04W 36/0007; H04W 4/06; H04W 48/20; H04W 76/27

(57) ABSTRACT

The disclosure relates to a 5G or 6G communication system for supporting a higher data transmission rate. <u style=“single”>Embodiments herein disclose methods for handling multicast reception in network (1000) by UE (100). The method includes determining multicast reception to be received in RRC inactive state, while UE is in mobility scenario. Further, the method includes receiving a message to support mobility scenario of UE in RRC INACTIVE state from network device (200). Further, the method includes handling the multicast reception of UE in the mobility scenario based on the message.

### TECHNICAL FIELD

Embodiments disclosed herein relate to wireless communication networks, and more particularly to systems and methods for managing the mobility of User Equipment (UEs) receiving New Radio Multicast Broadcast Service (NR MBS) multicast service.

### BACKGROUND ART

5G mobile communication technologies define broad frequency bands such that high transmission rates and new services are possible, and may be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile Broadband (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### DISCLOSURE OF INVENTION

### Technical Problem

The embodiments herein provides methods and systems for managing the mobility of UEs receiving MBS multicast service (e.g., NR MBS multicast service), where a UE may receive the multicast service in a RRC_INACTIVE state. Thus, results in ensuring reliable and efficient multicast service continuity in the wireless network.

### Solution to Problem

Accordingly, the embodiments herein provide methods for handling multicast reception in a wireless network. The method includes determining, by a UE, the multicast reception to be received in a radio resource control (RRC) inactive state, while the UE is in a mobility scenario. Further, the method includes receiving, by the UE, at least one message to support the mobility scenario of the UE in the RRC INACTIVE state from a network device. The at least one message includes at least one of: a multicast service coverage information to support mobility of the UE, a multicast-include list for a cell reselection for the multicast service, a multicast-exclude list for the cell reselection for the multicast service, a list of neighbour cell information, an applicability information for multicast configuration of the serving cell for at least one neighbour cell, a neighbor cell multicast configuration, a cell status indication for the multicast reception, a cell reservation indication for the multicast reception, a cell reselection priority and a priority of the frequency for cell reselection. Further, the method includes handling, by the UE, the multicast reception of the UE in the mobility scenario based on the at least one received message.

In an embodiment, the at least one multicast service coverage information includes at least one of a list of neighbour cells to a serving cell and a frequency that support a multicast service. The at least one multicast service coverage information is provided through at least one of a RRC reconfiguration message carrying a MBS Radio Bearer (MRB) configuration for the multicast service, a RRC Release with suspendconfig message carrying the MRB configuration for the multicast service reception, a System Information Broadcast (SIB), and a MBS Control Channel (MCCH) signalling.

In an embodiment, the UE does not consider a cell in the multicast-exclude list as candidate cell for the cell reselection, when the UE is interested to receive the multicast service in the RRC inactive state.

In an embodiment, the UE considers at least one cell in the multicast-include list as a candidate cell for the cell reselection, when the UE is interested to receive the multicast service in the RRC inactive state.

In an embodiment, at least one of the cell status indication and the cell reservation indication includes at least one of a multicastCellBarred field, a multicastCellBarred-inactive field, a multicastSupport field and a multicastSupport-inactive field. The multicastCellBarred field and the multicastCellBarred-inactive field indicates whether the cell is barred or not for the multicast reception in the RRC inactive state. The multicastSupport field and the multicastSupport-inactive field indicates whether the multicast reception is supported or not in the RRC inactive state. The cell status indication for the multicast reception, and the cell reservation indication for the multicast reception is received in at least one of a MIB message, a SIB1 message, a MBS SIB message, and a MCCH message.

In an embodiment, handling, by the UE, the multicast reception of the UE based on the received message includes reselecting a cell in a Radio Access Network based Notification Area (RNA) or a multicast coverage area, and continuing the multicast reception in the cell based on receiving an indication about all neighbour cells in the RNA or multicast coverage area comprising exactly same multicast MBS radio bearer (MRB) configuration information, as that of the serving cell, from the network device over the at least one message comprising the at least one neighbor cell multicast configuration.

In an embodiment, handling, by the UE, the multicast reception of the UE in the mobility scenario based on the received message includes prioritizing the cell, and reselecting the cell in the RNA or multicast coverage area and continuing the multicast reception in the cell based on receiving an indication about the neighbour cell in the RNA or the multicast coverage area comprising exactly same multicast MRB information, as that of the serving cell, from the network device over the at least one message comprising the at least one neighbor cell multicast configuration.

In an embodiment, handling, by the UE, the multicast reception of the UE based on the received message includes prioritizing the cell and reselecting the cell that provides the multicast service that the UE is interested in, based on receiving an indication about all neighbour cells in the RNA or multicast coverage area comprising different multicast MRB information, as that of the serving cell, from the network device over the at least one message comprising the at least one neighbor cell multicast configuration.

In an embodiment, the UE considers a frequency providing or supporting a multicast communication to be a highest priority while performing the cell reselection when the UE is configured to receive the multicast communication in the RRC INACTIVE state.

In an embodiment, the UE performs a prioritization on at least one of the neighbour cell and a frequency for the cell reselection based on at least one of a strongest cell belonging to a highest reselection priority frequency, a rank of the cell, a signal strength of the cell, a support of the prioritized multicast session on the cell, and a state of the multicast session support on the cell for the UE, and a support for maximum number of relevant multicast sessions on the cell for the UE.

In an embodiment, the UE re-derives a re-selection priority for a frequency by considering the multicast session supported by the cell, when the selected cell or frequency does not support the multicast session.

In an embodiment, the UE determines a priority of the frequency for the cell reselection based on at least one of a broadcast signalling message, a dedicated signalling message, a cell reselection priority message and a multicast-cell reselection priority message received from a network device.

In an embodiment, the UE derives reselection priorities for the cell reselection, while the UE is configured to receive the at least one multicast session in the RRC inactive state based on at least one of: a frequency that supports the at least one multicast session have higher re-selection priority than another frequency that support none of the multicast session, the frequency determined based on a cell reselection priority and a deprioritisation request for multicast, the frequency supporting the at least one multicast session prioritized based on a critical service, wherein the critical service comprises at least one of a public safety service, mission critical push-to-talk (MCPTT) service.

In an embodiment, handling, by the UE, the multicast reception of the UE in the mobility scenario based on the at least one received message includes indicating an interest to the network device upon determining the UE performs the cell reselection to a cell, where the cell does not provide at least one activated multicast service in which the UE is receiving. The indication is provided at least one of a MBS interest indication message, a UE assistance information message, a short message and a preconfigured random access preamble. The interest is indicated to the network device after the UE transits to a RRC connected state from the RRC inactive state.

In an embodiment, handling, by the UE, the multicast reception of the UE in the mobility scenario based on the at least one received message includes performing at least one of: continuing to monitor a group paging or notification (e.g. through a paging message or a MCCH message) for activation or deactivation of at least one multicast session and receiving at least one multicast session on a reselected cell, and determining a support of the multicast session and configuration of the multicast session on a reselected cell using neighbour cell information when the UE performs reselection to a neighbour cell.

In an embodiment, handling, by the UE, the multicast reception of the UE in the mobility scenario based on the at least one received message comprises at least one of stopping or deprioritizing a cell reselection to a cell or a frequency that does not support the at least one multicast session, and transiting to RRC connected state when a cell reselection to a cell or a frequency does not support the at least one multicast session that the UE is interested in. Further, UE stops monitoring the group paging or notification.

In an embodiment, the cell reselection for the UE interested to receive the multicast in the RRC inactive state is triggered when at least one of a performance trigger condition is met, a broadcasted signaling for a cell reselection is changed, a multicast session is changed, a MRB information is changed, a de-prioritization is changed, and a congestion status information is changed.

Accordingly, the embodiments herein provide methods for handling multicast reception in a wireless network. The method includes receiving, by a UE, a RRC Release with a suspend configuration. Further, the method includes receiving, by the UE, a de-prioritization request for a multicast configuration. Further, the method includes storing, by the UE, the de-prioritization request for the multicast configuration. Further, the method includes starting, by the UE, a timer. Further, the method includes maintaining, by the UE, the de-prioritization request for the multicast configuration until the timer is expired or release of the de-prioritization request for the multicast configuration is received. Further, the method includes performing, by the UE, a cell reselection in a RRC INACTIVE. Further, the method includes considering a current frequency or frequency indicated in the stored de-prioritization request for the multicast configuration as a lowest priority

Accordingly, the embodiments herein provide methods for handling multicast reception in a wireless network. The method includes sending, by a network device, at least one message to support a mobility scenario of a UE in a RRC inactive state to the UE. The at least one message comprises at least one of: a multicast service coverage information to support mobility of the UE, a multicast-include list for a cell reselection for the multicast service, a multicast-exclude list for the cell reselection for the multicast service, a list of neighbour cell information, an applicability information for multicast configuration of the serving cell for at least one neighbour cell, a neighbor cell multicast configuration, a cell status indication for the multicast reception, a cell reservation indication for the multicast reception, a cell reselection priority and a priority of the frequency for cell reselection. Further, the method includes handling, by the network device, the multicast reception of the UE based on the at least one message.

Accordingly, the embodiments herein provide a UE including a MBS multicast service controller coupled with a processor and a memory. The MBS multicast service controller is configured to determine the multicast reception to be received in a RRC inactive state, while the UE is in a mobility scenario. Further, the MBS multicast service controller is configured to receive at least one message to support the mobility scenario of the UE in the RRC INACTIVE state from a network device. The at least one message includes at least one of: a multicast service coverage information to support mobility of the UE, a multicast-include list for a cell reselection for the multicast service, a multicast-exclude list for the cell reselection for the multicast service, a list of neighbour cell information, an applicability information for multicast configuration of the serving cell for at least one neighbour cell, a neighbor cell multicast configuration, a cell status indication for the multicast reception, a cell reservation indication for the multicast reception, a cell reselection priority and a priority of the frequency for cell reselection. Further, the MBS multicast service controller is configured to handle the multicast reception of the UE based on the at least one received message.

Accordingly, the embodiments herein provide a UE including a MBS multicast service controller coupled with a processor and a memory. The MBS multicast service controller is configured to receive a RRC Release with a suspend configuration. Further, the MBS multicast service controller is configured to receive a de-prioritization request for a multicast configuration. Further, the MBS multicast service controller is configured to store the de-prioritization request for the multicast configuration. Further, the MBS multicast service controller is configured to start a timer and maintain the de-prioritization request for the multicast configuration until the timer is expired or release of the de-prioritization request for the multicast configuration is received. Further, the MBS multicast service controller is configured to perform a cell reselection in a RRC INACTIVE. Further, the MBS multicast service controller is configured to consider a current frequency or frequency indicated in the stored de-prioritization request for the multicast configuration as a lowest priority.

Accordingly, the embodiments herein provide a network device including a MBS multicast service controller coupled with a processor and a memory. The MBS multicast service controller is configured to send at least one message to support a mobility scenario of a UE in a RRC inactive state to the UE. The at least one message comprises at least one of: a multicast service coverage information to support mobility of the UE, a multicast-include list for a cell reselection for the multicast service, a multicast-exclude list for the cell reselection for the multicast service, a list of neighbour cell information, an applicability information for multicast configuration of the serving cell for at least one neighbour cell, a neighbor cell multicast configuration, a cell status indication for the multicast reception, a cell reservation indication for the multicast reception, a cell reselection priority and a priority of the frequency for cell reselection. Further, the MBS multicast service controller is configured to handle the multicast reception of the UE based on the at least one message.

According to an embodiment, a method performed by a user equipment (UE) in a communication system may be provided.

According to an embodiment, the method may include identifying frequency information associated with multicast broadcast service (MBS) service continuity in a radio resource control (RRC) inactive state.

According to an embodiment, the method may include performing cell reselection based on the frequency information.

According to an embodiment, the method may include identifying whether a reselected cell by the cell reselection is available for MBS multicast reception.

According to an embodiment, the method may include in case that the reselected cell is available for the MBS multicast reception: receiving, from the reselected cell, the MBS multicast reception in the RRC inactive state.

According to an embodiment, the method may include in case that the reselected cell is not available for the MBS multicast reception: transitioning to a RRC connected state; and receiving the MBS multicast reception in the RRC connected state.

According to an embodiment, the MBS multicast reception may be an MBS multicast reception to receive by the UE or to continue receiving by the UE.

According to an embodiment, the frequency information may include frequency prioritization for the MBS multicast reception.

According to an embodiment, the frequency information may include a first list of frequencies on which MBS multicast being available and a second list of frequencies on which the MBS multicast being not available.

According to an embodiment, the reselected cell may be corresponded to a frequency included in the first list.

According to an embodiment, the frequency information may be obtained via broadcast signaling or dedicated signaling.

According to an embodiment, a user equipment (UE) in a communication system may be provided.

According to an embodiment, the UE may include a transceiver; and a processor coupled with the transceiver.

According to an embodiment, the processor may be configured to identify frequency information associated with multicast broadcast service (MBS) service continuity in a radio resource control (RRC) inactive state.

According to an embodiment, the processor may be configured to perform cell reselection based on the frequency information.

According to an embodiment, the processor may be configured to identify whether a reselected cell by the cell reselection is available for MBS multicast reception.

According to an embodiment, the processor may be further configured to: in case that the reselected cell is available for the MBS multicast reception: receive, from the reselected cell, the MBS multicast reception in the RRC inactive state.

According to an embodiment, the processor may be further configured to in case that the reselected cell is not available for the MBS multicast reception: transit to a RRC connected state; and receive the MBS multicast reception in the RRC connected state.

According to an embodiment, the MBS multicast reception may be an MBS multicast reception to receive by the UE or to continue receiving by the UE.

According to an embodiment, the frequency information may include frequency prioritization for the MBS multicast reception.

According to an embodiment, the frequency information may include a first list of frequencies on which MBS multicast being available and a second list of frequencies on which the MBS multicast being not available.

According to an embodiment, wherein the reselected cell may be corresponded to a frequency included in the first list.

According to an embodiment, a method performed by a base station in a communication system may be provided.

According to an embodiment, the method may include transmitting, to a user equipment (UE), information associated with frequency information.

According to an embodiment, the frequency information may be associated with multicast broadcast service (MBS) service continuity in a radio resource control (RRC) inactive state.

According to an embodiment, the method may include provide, to the UE in the RRC inactive state, MBS multicast transmission on a cell associated with the frequency information in case that the cell is available for the MBS multicast transmission.

According to an embodiment, a base station in a communication system may be provided.

According to an embodiment, the base station may include a transceiver; and a processor coupled with the transceiver.

According to an embodiment, the processor may be configured to transmit, to a user equipment (UE), information associated with frequency information.

According to an embodiment, the frequency information may be associated with multicast broadcast service (MBS) service continuity in a radio resource control (RRC) inactive state.

According to an embodiment, the processor may be configured to provide, to the UE in the RRC inactive state, MBS multicast transmission on a cell associated with the frequency information in case that the cell is available for the MBS multicast transmission.

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the spirit thereof, and the embodiments herein include all such modifications.

### Advantageous Effects of Invention

According to an embodiment, methods and systems may be provided for managing the mobility of UEs receiving MBS multicast service (e.g., NR MBS multicast service), where a UE may receive the multicast service in a RRC_INACTIVE state. Thus, results in ensuring reliable and efficient multicast service continuity in the wireless network.

### BRIEF DESCRIPTION OF DRAWINGS

The embodiments disclosed herein are illustrated in the accompanying drawings, throughout which like reference letters indicate corresponding parts in the various figures. The embodiments herein will be better understood from the following description with reference to the drawings, in which:

FIG. 1 illustrates a wireless network for handling multicast reception in the RRC inactive state, according to the embodiments as disclosed herein;

FIG. 2 shows various hardware components of a UE, according to the embodiments as disclosed herein;

FIG. 3 shows various hardware components of a network device, according to the embodiments as disclosed herein;

FIG. 4 is a flow chart illustrating a method, implemented by the UE, for handling the multicast reception in the RRC inactive state in the wireless network, according to the embodiments as disclosed herein;

FIG. 5 is a flow chart depicting a method, implemented by the UE, for enabling the UE to perform cell reselection in the RRC inactive state in the wireless network, according to embodiments as disclosed herein;

FIG. 6 is a flow chart illustrating a method, implemented by the network device, for handling the multicast reception in the RRC inactive state in the wireless network, according to the embodiments as disclosed herein; and

FIG. 7 is an example flow chart illustrating a method for managing a mobility of UEs receiving a NR MBS multicast service in the RRC inactive state, according to embodiments as disclosed herein.

FIG. 8 illustrates an electronic device according to embodiments of the present disclosure.

FIG. 9 illustrates a base station according to embodiments of the present disclosure.

### MODE FOR THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

NR MBS services may refer to multicast services where intended common contents are targeted to a group of User Equipment's (UEs), which have joined a multicast group in a multicast coverage area and broadcast services where the intended contents may be targeted to all the UEs in a broadcast coverage area. This coverage area may be one radio cell or larger. In the legacy system (i.e., 3^{rd} Generation Partnership Project (3GPP) Release 17 MBS), the UEs receive multicast services only in a RRC_CONNECTED state. However, there may also be UEs which may receive multicast session(s) in a RRC_INACTIVE state (for example, 3GPP Release 18 MBS may consider such a scenario).

A potential issue relates to the UEs that are capable of receiving MBS multicast service in the RRC_INACTIVE state. In certain scenarios, for example, the UEs in the RRC_INACTIVE state may perform mobility (for example, cell reselection) and may go out of the coverage of a multicast service. That is, the UEs may suffer service outage due to mobility and there is no clear mechanism which ensures the multicast service sustenance and continuity along with the mobility of the UEs.

It is desired to address the above mentioned disadvantages or other short comings or at least provide a useful alternative.

The embodiments herein achieve methods for handling multicast reception in a wireless network. The method includes determining, by a UE, the multicast reception to be received in a RRC inactive state, while the UE is in a mobility scenario. Further, the method includes receiving, by the UE, at least one message to support the mobility scenario of the UE in the RRC INACTIVE state from a network device. The at least one message includes at least one of: a multicast service coverage information to support mobility of the UE, a multicast-include list for a cell reselection for the multicast service, a multicast-exclude list for the cell reselection for the multicast service, a list of neighbour cell information (e.g. neighbor cell information may include a bit, a bitmap or a field indicating the availability or non-availability of at least one MBS session of the serving cell for at least one neighbor cell), an applicability information for multicast configuration of the serving cell for at least one neighbour cell (e.g. neighbor cell information may include a bit, a bitmap or a field indicating the applicability or the non-applicability of the multicast configuration of at least one MBS session of the serving cell for at least one neighbor cell), a neighbor cell multicast configuration, a cell status indication for the multicast reception, a cell reservation indication for the multicast reception, a cell reselection priority and a priority of the frequency for cell reselection. Further, the method includes handling, by the UE, the multicast reception of the UE in the mobility scenario based on the at least one received message.

In an embodiment, when the list of neighbor cell information is absent, the UE interprets that the multicast session reception is not available on the neighbor cell. In an alternative embodiment, when the list of neighbor cell information is absent, the UE interprets that the multicast session reception may be available on the neighbor cell. In an alternative embodiment, when the list of neighbor cell information is absent, the UE does not interpret anything about availability or non-availability of the multicast session on the neighbor cell.

In an embodiment, the neighbour cell may be indicated by a physical cell identity field and/or a carrier frequency field. In case the carrier frequency field is absent, the frequency is considered to the same frequency of the serving cell that provided the neighbor cell information to the UE in the RRC Release with suspendConfig or in the multicast MCCH message.

In an embodiment, the UE checks SIB1 and/or multicast MCCH on the neighbor cell selected or cell reselected and determine if the multicast session is provided on the cell. If the selected cell or the reselected cell does not provide the configuration of the multicast session that the UE is interested in receiving in the multicast MCCH message, the UE resumes the RRC connection in to avail multicast MBS radio bearer configuration and receive multicast session.

In an embodiment, the UE prioritizes and considers the serving cell that provided the point to multi point (PTM) configuration to the UE in the RRC Release with suspendConfig for cell selection/reselection e.g. when transiting from RRC_CONNECTED state to RRC_INATIVE state.

In an embodiment, the UE prioritizes and considers the serving cell that provided the PTM configuration to the UE in the RRC Release with suspendConfig and/or at least one neighbor cell that is included in the neighbor cell information and provides multicast session that the UE is interested in and/or configured to receive in RRC_INACTIVE state, for cell selection/reselection (for example) when transiting from the RRC_CONNECTED state to the RRC_INATIVE state.

In an embodiment, the UE prioritizes and considers the serving cell that provided the PTM configuration to the UE in the RRC Release with suspendConfig and/or at least one neighbor cell that is included in the neighbor cell information and has same multicast MRB configuration as that of the serving cell that provided the PTM configuration to the UE in the RRC Release with suspendConfig for cell selection/reselection e.g. when transiting from RRC_CONNECTED state to RRC_INATIVE state.

The method may be used for managing the mobility of UEs receiving NR MBS multicast service, where the UE may receive the multicast service in the RRC INACTIVE state. The method may be used to ensure the multicast service sustenance and continuity along with the mobility of the UEs in the RRC INACTIVE state.

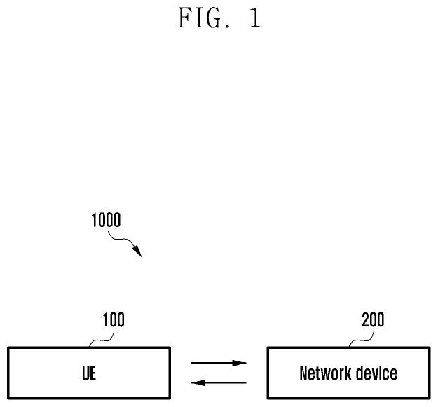

Referring now to the drawings, and more particularly to FIGS. 1 through 7, where similar reference characters denote corresponding features consistently throughout the figures, there are shown at least one embodiment.

FIG. 1 illustrates a wireless network (1000) for handling multicast reception in the RRC inactive state, according to the embodiments as disclosed herein. The wireless network (1000) may be, for example, but not limited to a fourth generation (4G) network, a fifth generation (5G) network, an Open Radio Access Network (ORAN) or the like.

In an embodiment, the wireless network (1000) includes a UE (100) and a network device (200). The UE (100) may be, for example, but not limited to a laptop, a smart phone, a desktop computer, a notebook, a Device-to-Device (D2D) device, a vehicle to everything (V2X) device, a foldable phone, a smart TV, a tablet, an immersive device, and an internet of things (IoT) device. The network device (200) may be, for example, but not limited to a gNB, a eNB, a new radio (NR) trans-receiver or the like.

The UE (100) determines a multicast reception to be received in a RRC inactive state, while the UE (100) is in a mobility scenario. Further, the UE (100) receives a message to support the mobility scenario of the UE (100) in the RRC INACTIVE state from the network device (200). The message may be, for example, but not limited to a multicast service coverage information to support mobility of the UE (100), a multicast-include list for a cell reselection for the multicast service, a multicast-exclude list for the cell reselection for the multicast service, a list of neighbour cell information, applicability information for multicast configuration of the serving cell for the at least one neighbour cell, the neighbor cell multicast configuration, the cell status indication for the multicast reception, the cell reservation indication for the multicast reception, a cell reselection priority and the priority of the frequency for cell reselection. Based on the received message, the UE (100) handles the multicast reception of the UE (100). Handling of the multicast reception of the UE (100) is explained in below.

Particularly, the UEs (100) which are supporting 3GPP Release 18 MBS may be capable and/or configured to receive multicast in the RRC_INACTIVE state whereas the UEs (100) pertaining to previous release (i.e., 3GPP Release 17 MBS) may not be capable and/or not configured to receive multicast in an RRC_INACTIVE state. Coexistence of these two sets of UEs (100) in the same cell/network is feasible and needs to be supported. Further, there is a need for mechanism which ensures the multicast service sustenance and continuity in the RRC_INACTIVE state along with the mobility of the UEs (100).

In an embodiment, the network device (for example, the gNB or the like) (200) provides the UE (100) with the one or more multicast service(s) coverage information to support mobility of the UEs (100) in the RRC_INACTIVE state. This information may be the list of neighbour cell(s) to the serving cell and/or frequencies that support the same multicast service. This information is provided through at least one of RRC reconfiguration message carrying the MBS Radio Bearer (MRB) configuration for the multicast services or RRC Release with suspendconfig carrying the MRB configuration for the multicast service reception in the RRC_INACTIVE state or a broadcast signalling approach in the RRC_INACTIVE state (for example, a System Information Broadcast (SIB) or a MBS Control Channel (MCCH) conveys this information).

In an embodiment, the network device (200) provides the UE (100) with the multicast-include list (or whitelisted cells) and/or the multicast-exclude list (or blacklisted cells) for the cell reselection for the multicast reception in the RRC_INACTIVE state. The UE (100) does not consider any cell in the multicast-exclude list as candidate for cell reselection, when the UE (100) is interested to receive and/or receiving multicast in the RRC_INACTIVE state. The UE (100) considers only the cells in the multicast-include list as candidates for cell reselection, when the UE (100) is interested to receive and/or receiving multicast in the RRC_INACTIVE state.

In an embodiment, the network device (200) provides the UE (100) with the cell status and cell reservations indications for the multicast reception in the MIB or one of a SIB (e.g. SIB1, or a MBS SIB) or MCCH message. The indications may include a field “multicastCellBarred” (or “multicastCellBarred-Inactive”) that may indicate that the cell is barred or the cell is not barred for multicast reception (or multicast reception in RRC_INACTIVE). The field is only applicable to the UE (100) interested to receive and/or receiving multicast service (or to the UE (100) interested to receive and/or receiving the multicast service in the RRC_INACTIVE). The field may be common for all Public Land Mobile Networks (PLMNs) (or all Stand-alone Non-Public Networks (SNPNs), if provided in the SIB1. If the cell status multicastCellBarred is barred, the UE (100) may exclude the barred cell as candidate for the cell selection and/or reselection (e.g. for 300 seconds) and the UE (100) may select another cell on the same frequency, if the re-selection criteria is satisfied.

In an embodiment, the network device (200) provides the UE (100) with the cell status and cell reservations indications for the multicast reception in the MIB or one of a SIB (e.g. SIB1, or a MBS SIB) or the MCCH message. The indications may include a field “multicastSupport” (or “multicastSupport-Inactive”) that may indicate whether multicast is supported (or whether multicast is supported in the RRC_INACTIVE). The field is only applicable to the UE (100) interested to receive and/or receiving multicast service (or to the UE (100) interested to receive and/or receiving multicast service in RRC_INACTIVE). The field may also be provided per PLMN (or per SNPN), if provided in the SIB1. If the cell status multicastSupport is TRUE, the UE (100) considers the cell as the candidate for the cell selection and/or reselection.

In an embodiment, the network device (200) provides the neighbor cell's multicast configuration for the UE (100) moving to other cells in the same Radio Access Network based Notification Area (RNA) or multicast coverage area. This may involve one or more options as described below:
a) All neighbour cells in the RNA have exactly same multicast MRB information: the network device (e.g., gNB or the like) indicates it. Based on the multicast MRB information, the UE (100) reselects any cell in the RNA and continues the multicast reception.
b) Neighbor cell has exactly same multicast MRB information: the network device (e.g., gNB) may indicate the neighbor cell. The UE (100) may prioritize the cell. Based on the indication, the UE (100) reselects the cell and continues the multicast reception.
c) Neighbor cell has different multicast MRB information: The gNB may provide the neighbor cell's MRB configuration. Based on the neighbor cell's MRB configuration, the UE (100) may prioritize the cell which is providing the multicast services UE (100) is interested in.
d) Neighbor cell does not provide the multicast MRB information UE (100) is interested in: When the UE (100) reselects the cell, UE (100) has to enter RRC_CONNECTED. It may be based on the group paging or on its own. Also, the UE (100) needs to indicate to the gNB that the UE (100) is interested in the multicast services.

In an embodiment, when the UE (100) performs the cell reselection to the cell which does not provide “all” activated multicast services which the UE (100) is receiving, the UE (100) indicates its interest to the network device (200). The indication may be either a MBS Interest Indication message or the UE assistance information message or short message or pre-configured random access preamble. The UE (100) may transit to a RRC_CONNECTED state in order to transmit the indication.

In another embodiment, when the UE (100) performs cell reselection to the cell which does not provide “any” activated multicast services which the UE (100) is receiving, the UE (100) indicates its interest to the network device (200). The indication may be either the MBS Interest Indication message or the UE assistance information message or the short message or the pre-configured random access preamble. The UE (100) may transit to the RRC_CONNECTED state in order to transmit the indication.

In an embodiment, the UE (100) in the RRC_INACTIVE state may have the at least one multicast session in the deactivated state (i.e., the UE (100) may be monitoring for the group paging or the notification for “activation” of the multicast session) and/or the at least one multicast session is in the activated state (i.e., the UE (100) is receiving the multicast session and may be monitoring for the group paging or notification for “deactivation” of the multicast session). The group paging or notification may be provided through a paging message or a MCCH message. When the UE (100) performs reselection to a neighbour cell, the UE (100) continues to monitor group paging or notification for activation or deactivation of the multicast session(s) and/or receiving the multicast session(s) on the reselected cell based on the deactivated or activated state of the multicast session(s), provided that the network's given neighbour cell information conveys support of the multicast session(s) and/or configuration of the multicast session(s) on the reselected cell.

In an embodiment, when the UE (100) is configured to receive multicast communication in the RRC_INACTIVE state, the UE (100) may consider the frequency providing multicast communication configuration to be the highest priority when performing cell reselection.

In an embodiment, the UE (100) performs prioritization among the neighbour cells and/or frequency for cell reselection based on at least one of the following factors
a) Strongest cell belonging to highest reselection priority frequency.
b) Rank of the cell and/or Signal strength of the cell.
c) Support of the prioritized multicast session(s) on the cell.
d) State of the multicast session(s) (for example, activated or deactivated state) support on the cell for the UE (100).
e) Support for maximum number of relevant multicast session(s) on the cell for the UE (100).

In an embodiment, for the UE (100) that is configured to receive and/or receiving one or more multicast session(s) in the RRC_INACTIVE state and is performing cell reselection if a best cell in a frequency fulfils the “S” criteria for cell reselection based on re-selection priority for the frequency, but this cell does not support the one or more or all multicast session(s), the UE (100) shall re-derive a re-selection priority for the frequency by considering the multicast session(s) supported by this cell (rather than those of the corresponding NR frequency). The reselection priority is used for a maximum of 300 seconds, or until new information of multicast session(s) (for example, release of multicast session) and/or change of the UE's interest of multicast session(s) is received. The UE (100) shall ensure the cell reselection criteria above are fulfilled based on the newly derived priorities.

In an embodiment, the UE (100) derives reselection priorities for cell reselection, while the UE (100) is configured to receive and/or receiving multicast session in the RRC_INACTIVE state according to at least one of the following rules:
a) Frequencies that support the at least one multicast session that the UE (100) is interested to receive and/or receiving in RRC_INACTIVE state have higher re-selection priority than frequencies that support none of the multicast session(s) that UE (100) is interested to receive and/or receiving in RRC_INACTIVE state.
b) Frequencies that support at least one multicast session that the UE (100) is interested to receive and/or receiving in RRC_INACTIVE state are prioritized in the order of at least one of their priority or criticality with the highest priority or criticality supported on the frequency or more number of relevant multicast sessions for the supported UE (100). Criticality may refer to the emergency or critical communication like public safety service or mission critical push-to-talk (MCPTT) service.
c) Frequencies that support none of the multicast session that the UE (100) is interested to receive and/or receiving in RRC_INACTIVE state are prioritized in the order of their cellReselectionPriority.
d) Frequencies that are indicated as part of deprioritisationReqforMulticast are considered as lowest priority or restricted for cell reselection.
e) The frequencies and/or priorities of the frequencies for the multicast session(s) reception in the RRC_INACTIVE are considered that are provided to the UEs (100) in broadcast signalling like User Service Description (USD) message and/or system information block (SIB) message.

In an embodiment, the highest ranked cell or the best cell according to the absolute priority reselection rule (which may be intra-frequency or inter-frequency cell) is not the candidate for reselection, due to no support for multicast and/or no support for relevant multicast session and/or is signalled as not in the multicast coverage and/or pertains to deprioritisationReqforMulticast, the UE (100) may not consider this cell and/or other cells on the same frequency as candidates for re-selection. The UE (100) may not consider this cell and/or other cells on the same frequency as candidates for re-selection for a pre-defined maximum time period. In an example herein, the UE (100) may not consider this cell and/or other cells on the same frequency as candidates for re-selection for a maximum of 300 seconds.

In an embodiment, cell reselection for the UE (100) interested to receive and/or receiving multicast in the RRC_INACTIVE state is triggered when at least one of the performance trigger(s) condition is met (e.g. the UE (100) measured channel condition is meeting a determined threshold for a multicast reception performance), broadcasted signaling for the cell reselection changes (e.g. cell reselection configuration parameter changes in SIB or MCCH), multicast session/MRB information is changed (e.g. multicast session is released, the UE's interest in multicast session changes, session is deactivated or activated) and de-prioritization/congestion status information is changed.

In an embodiment, cell reselection for the UE (100) receiving the one or more multicast session(s) in the RRC_INACTIVE state is prevented or de-prioritized to the cell or the frequency that does not support the one or more multicast session(s).

In another embodiment, the cell reselection for the UE (100) receiving the one or more multicast session(s) in the RRC_INACTIVE state is prevented or de-prioritized to the cell or the frequency that does not support the one or more multicast session(s) configured for the UE (100) and which the UE (100) is receiving.

In an embodiment, when the UE (100) is moving across the cells, the gNB conveys the multicast session information (for example, TMGI, session configuration) to the other gNB(s) (for example). The gNB may convey the multicast session information for the UE (100) to one or more gNBs through the Xn interface. The gNBs may belong to the same RNA.

In an embodiment, the UE (100) may be provided by the network device (200) in at least one of the broadcast signaling (e.g. system information block (SIB) or MCCH) and/or dedicated signaling (e.g. RRC reconfiguration message, RRC Release message, RRCRelease with suspendConfig message), cellReselectionPriority and/or multicast-cellReselectionPriority that determines the priority of the frequency for the cell reselection. In an embodiment, multicast-cellReselectionPriority may be applicable only to the UE (100) which is configured and/or interested to receive multicast. In some cases, this may be restricted to the UE (100) which is configured/capable and/or interested to receive and/or receiving multicast in the RRC_INACTIVE state.

In an embodiment, If any fields with cellReselectionPriority or multicast-CellReselectionPriority are provided in dedicated signalling, the UE (100) shall ignore any fields with cellReselectionPriority and multicast-CellReselectionPriority provided in system information. Validity of the priorities provided by dedicated signaling may be up to a configured time limit (e.g. a timer T320 expiry).

In an embodiment, the network device (200) provides the UE (100) with the “de-prioritization configuration for the multicast reception” to guide the cell reselection procedure in the RRC_INACTIVE state. The de-prioritization configuration for multicast reception may be provided through at least one of RRC Release with suspendconfig message (when the UE (100) is being transitioned from RRC_CONNECTED to RRC_INACTIVE) or RRCReject message (when the UE (100) is attempting to access the network). The de-prioritization configuration for multicast reception may consists of one or more set of configuration(s) of at least one of the frequency, Radio Access Technology (RAT, for example, NR), cell identity, multicast session identity (for example, TMGI), a de-prioritization timer Txyz configuration, a cause of de-prioritization (for example, congestion, overload), applicable RRC state(s). The de-prioritization configuration for multicast reception may be applicable only for the UEs (100) which are interested to receive multicast session and/or receiving the multicast session. In an embodiment, the de-prioritization configuration for multicast reception may be applicable only for the UEs which are configured/capable and/or interested to receive multicast session and/or receiving the multicast session in the RRC_INACTIVE state.

In an embodiment, the UE (100) stores the de-prioritization configuration for multicast reception and maintains one or more instance(s) of the timer Txyz, when the UE (100) receives de-prioritization configuration for multicast reception with one or more timer configuration(s). The UE (100) may receive multiple de-prioritization for multicast reception at different points of time; for example, during multiple RRCReject or RRCRelease with SuspendConfig when a previous de-prioritization configuration for the multicast reception is/are already stored with the UE (100). With different instances of timer Txyz, multiple different de-prioritization configuration for multicast reception pertaining to different frequencies may be handled effectively and correctly. Examples of specification text is presented as follows:

### Example 1

1> if deprioritisationReqforMulticast is included in RRCRelease including SuspendConfig and the UE (100) supports RRC connection release with deprioritisation for multicast:
2> start timer Txyz with the timer value set to the deprioritisationTimer signalled;
2> store the deprioritisationReqforMulticast until Txyz expiry;

### Example 2

1> if deprioritisationReqforMulticast is included in RRCRelease including SuspendConfig and the UE (100) supports RRC connection release with deprioritisation for multicast:
2> start an instance of timer Txyz with the timer value set to the deprioritisationTimer signalled;
2> store the deprioritisationReqforMulticast until the relevant instance of timer Txyz expiry;

In an embodiment, the UE (100) stores the one or more deprioritisationReqforMulticast until the expiry of the relevant instance of Txyz timer expiry, irrespective of the RRC state change and/or cell reselection absolute priority assignments by dedicated or common signaling.

In an embodiment, the UE (100) stores the one or more deprioritisationReqforMulticast until the expiry of a common and single Txyx timer expiry, irrespective of the RRC state change and/or cell reselection absolute priority assignments by dedicated or common signaling. Txyz timer is started and/or restarted when the UE (100) receives a new deprioritisationReqforMulticast from the network.

In an embodiment, if the UE (100) receives a deprioritisationReqforMulticast in the RRC Release with suspendConfig and/or broadcast signalling, the UE (100) may consider current frequency and stored frequencies due to the previously received deprioritisationReqforMulticast in the RRC Release with suspendConfig and/or broadcast signalling to be the lowest priority frequency (i.e. lower than any of the network configured values) while relevant Txyz is running. The UE (100) may delete the stored deprioritisationReqforMulticast request(s) when a PLMN selection or SNPN selection is performed on request by NAS.

In an embodiment, a deprioritisationReqforMulticast is provided to the UE (100) in order to transit the UE (100) and/or keep the UE (100) in the RRC_INACTIVE state to receive or to continue receiving the multicast service when there is overload or congestion on the current cell or frequency. Further, the deprioritisationReqforMulticast is released when the overload or congestion on the current cell or frequency is not applicable and the UE (100) may transit to RRC_CONNECTED to receive or continue to receive the multicast service.

In an embodiment, an example structure for de-prioritization configuration for multicast reception is presented as follows:

| | |
|---|---|
| RRCRelease ::= | SEQUENCE { |
| rrc-TransactionIdentifier | RRC-TransactionIdentifier, |
| criticalExtensions | CHOICE { |
| rrcRelease | RRCRelease-IEs, |
| criticalExtensionsFuture | SEQUENCE { } |

}
}
....

| | |
|---|---|
| SuspendConfig ::= | SEQUENCE { |
| fullI-RNTI | I-RNTI-Value, |
| shortI-RNTI | ShortI-RNTI-Value, |
| ran-PagingCycle | PagingCycle, |

| | |
|---|---|
| ran-NotificationAreaInfo | RAN-NotificationAreaInfo |

OPTIONAL, -- Need M

| | |
|---|---|
| t380 | PeriodicRNAU-TimerValue |

OPTIONAL, -- Need R

| | |
|---|---|
| nextHopChainingCount | NextHopChainingCount, |

```
    ...,
    [[
```

| | |
|---|---|
| sl-ServingCellInfo-r17 | SL-ServingCellInfo-r17 |

OPTIONAL, -- Cond L2RemoteUE

| | |
|---|---|
| sdt-Config-r17 | SetupRelease { SDT-Config-r17 } |

OPTIONAL, -- Need M

| | |
|---|---|
| srs-PosRRC-InactiveConfig-r17 | SRS-PosRRC-InactiveConfig-r17 |

OPTIONAL, -- Need M

| | |
|---|---|
| deprioritisationReqforMulticast-r18 | SEQUENCE { |

| | |
|---|---|
| deprioritisationType | ENUMERATED {frequency, nr}, |
| deprioritisationTimer | ENUMERATED {min5, min10, min15, min30} |

deprioritisationMulticastSessionIdList TMGIList,

| | |
|---|---|
| deprioritisationCause | Enumerated {Congestion, overload} |

}
.....

| | |
|---|---|
| ran-ExtendedPagingCycle-r17 | ExtendedPagingCycle-r17 |

OPTIONAL -- Need R
]]
}

In an embodiment, de-prioritization for multicast reception (and/or congestion indication, in general, to inhibit the UE (100) to attempt transition to the RRC_CONNECTED state) is signalled to the UE (100) which is already in the RRC_INACTIVE state (and/or RRC_IDLE state) by providing the information through a broadcasted signalling. The broadcasted signalling may include at least one of SIB, MCCH and group paging or notification.

In an embodiment, the network device (200) may release (or remove) the de-prioritization for multicast reception (and/or release/remove congestion indication, in general, to allow the UE (100) to attempt accessing to multicast in RRC_CONNECTED state) for the UEs (100). The release of de-prioritization for multicast reception (and/or release of congestion indication) may be provided through dedicated RRC signalling and/or broadcasted signalling that may include at least one of SIB, MCCH and group paging or notification.

In an embodiment, the UE (100) removes one or more stored deprioritisationReqforMulticast when the UE (100) receives release of relevant deprioritisationReqforMulticast and the UE (100) stops and resets the relevant Txyz timer.

In an embodiment, on reception of the RRCRelease with SuspendConfig message to transition to the RRC_INACTIVE state, the UE (100) may attempt to camp on a suitable cell according to redirectedCarrierInfo and/or redirectedCarrierInfoMulticast, if included in the message, which guides the UE (100) to the cell/frequency supporting the multicast session(s) to be received in the RRC_INACTIVE. If the RRCRelease message does not contain the redirectedCarrierInfo and/or redirectedCarrierInfoMulticast, the UE (100) shall attempt to select a suitable cell on an NR carrier that may support multicast reception. If no suitable cell is found according to the above, the UE (100) shall perform cell selection using stored information in order to find a suitable cell to camp on that may support multicast reception.

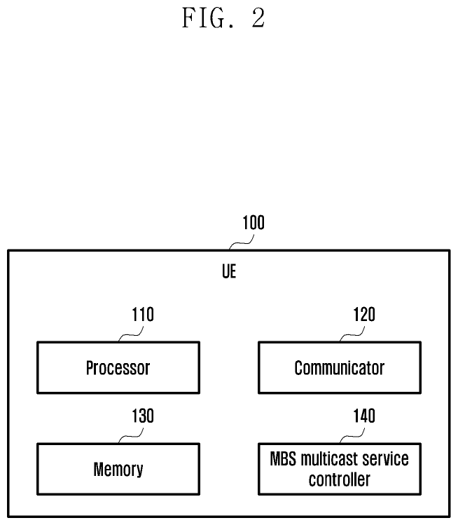

FIG. 2 shows various hardware components of the UE (100), according to the embodiments as disclosed herein. In an embodiment, the UE (100) includes a processor (110), a communicator (120), a memory (130) and a MBS multicast service controller (140). The processor (110) is coupled with the communicator (120), the memory (130) and the MBS multicast service controller (140).

The MBS multicast service controller (140) determines the multicast reception to be received in the RRC inactive state, while the UE (100) is in the mobility scenario. Further, the MBS multicast service controller (140) receives the message to support the mobility scenario of the UE (100) in the RRC INACTIVE state from the network device (200). The message may be, for example, but not limited to the multicast service coverage information to support mobility of the UE (100), the multicast-include list for the cell reselection for the multicast service, the multicast-exclude list for the cell reselection for the multicast service, the list of neighbour cell information, the applicability information for the multicast configuration of the serving cell for at least one neighbour cell, the neighbor cell multicast configuration, the cell status indication for the multicast reception, the cell reservation indication for the multicast reception, the cell reselection priority and the priority of the frequency for cell reselection.

In an embodiment, the multicast service coverage information includes the list of neighbour cells to the serving cell and the frequency that support the multicast service. The multicast service coverage information is provided through at least one of the RRC reconfiguration message carrying the MRB configuration for the multicast service, the RRC Release with suspendconfig message carrying the MRB configuration for the multicast service reception, the SIB, and the MCCH signalling.

The cell status indication and the cell reservation indication includes the multicastCellBarred field, the multicastCellBarred-inactive field, the multicastSupport field and the multicastSupport-inactive field. The multicastCellBarred field and/or the multicastCellBarred-inactive field indicates whether the cell is barred or not for the multicast reception in the RRC inactive state. The multicastSupport field and the multicastSupport-inactive field indicates whether the multicast reception is supported or not in the RRC inactive state. The cell status indication for the multicast reception, and the cell reservation indication for the multicast reception is received in at least one of the MIB message, the SIB1 message, the MBS SIB message, and the MCCH message.

Based on the received message, the MBS multicast service controller (140) handles the multicast reception of the UE (100).

In an example, the MBS multicast service controller (140) reselects the cell in the RNA or the multicast coverage area, and continues the multicast reception in the cell based on receiving the indication about all neighbour cells in the RNA comprising exactly same multicast MBS radio bearer (MRB) configuration information from the network device (200) over the message comprising the neighbor cell multicast configuration.

In another example, the MBS multicast service controller (140) prioritizes the cell and reselects the cell in the RNA or multicast coverage area. Further, the MBS multicast service controller (140) continues the multicast reception in the cell based on receiving the indication about all neighbour cells in the RNA or the multicast coverage area comprising exactly same multicast MRB information, as that of the serving cell, from the network device (200) over the message comprising the neighbor cell multicast configuration.

In another example, the MBS multicast service controller (140) prioritizes the cell and reselects the cell that provides the multicast service that the UE (100) is interested in, based on receiving the indication about all neighbour cells in the RNA or the multicast coverage area comprising different multicast MRB information, as that of the serving cell, from the network device (200) over the message comprising the neighbor cell multicast configuration.

In another example, the MBS multicast service controller (140) indicates the interest to the network device (200) upon determining the UE (100) performs the cell reselection to the cell, where the cell does not provide the activated multicast service in which the UE (100) is receiving. The indication is provided at least one of the MBS interest indication message, the UE assistance information message, the short message and the pre-configured random access preamble. The interest is indicated to the network device (200) after the UE (100) transits to the RRC connected state from the RRC inactive state.

In another example, the MBS multicast service controller (140) performs at least one of: continuing to monitor a group paging or notification for activation or deactivation of the multicast session and receiving the multicast session on a reselected cell. Further, the MBS multicast service controller (140) determines a support of the multicast session and configuration of the multicast session on a reselected cell using neighbour cell information when the UE (100) performs reselection to the neighbour cell.

In another example, the MBS multicast service controller (140) stops or deprioritizes the cell reselection to the cell or the frequency that does not support the multicast session. In another example, the MBS multicast service controller (140) transits to the RRC connected state when the cell reselection to a cell or a frequency does not support the multicast session that the UE (100) is interested in. Further, MBS multicast service controller (140) stops monitoring the group paging or the notification.

In an embodiment, the MBS multicast service controller (140) does not consider the cell in the multicast-exclude list as candidate cell for the cell reselection, when the UE (100) is interested to receive the multicast service in the RRC inactive state.

In another embodiment, the MBS multicast service controller (140) considers the cell in the multicast-include list as the candidate cell for the cell reselection, when the UE (100) is interested to receive the multicast service in the RRC inactive state.

In another embodiment, the MBS multicast service controller (140) considers a frequency providing or supporting a multicast communication to be the highest priority while performing the cell reselection when the UE (100) is configured to receive the multicast communication in the RRC INACTIVE state.

In another embodiment, the MBS multicast service controller (140) performs a prioritization on at least one of the neighbour cell and the frequency for the cell reselection based on at least one of the strongest cell belonging to the highest reselection priority frequency, the rank of the cell, the signal strength of the cell, the support of the prioritized multicast session on the cell, and the state of the multicast session support on the cell for the UE (100), and the support for maximum number of relevant multicast sessions on the cell for the UE (100).

In another embodiment, the MBS multicast service controller (140) re-derives the reselection priority for the frequency by considering the multicast session supported by the cell, when the selected cell or frequency does not support the multicast session.

In another embodiment, the MBS multicast service controller (140) determines the priority of the frequency for the cell reselection based on at least one of the broadcast signalling message, the dedicated signalling message, the cell reselection priority message and the multicast-cell reselection priority message received from the network device (200).

In another embodiment, the MBS multicast service controller (140) derives reselection priorities for the cell reselection, while the UE (100) is configured to receive the at least one multicast session in the RRC inactive state based on at least one of: a frequency that supports the at least one multicast session have higher re-selection priority than another frequency that support none of the multicast session, the frequency determined based on a cell reselection priority and the deprioritisation request for multicast, the frequency supporting the at least one multicast session prioritized based on a critical service, wherein the critical service comprises at least one of a public safety service, mission critical push-to-talk (MCPTT) service.

In an embodiment, the cell reselection for the UE (100) interested to receive the multicast in the RRC INACTIVE state is triggered when at least one of the performance trigger condition is met (e.g. the UE measured channel condition is meeting a determined threshold for a multicast reception performance), the broadcasted signaling for the cell reselection changes (e.g. cell reselection configuration parameter changes in SIB or MCCH), multicast session/MRB information is changed (e.g. multicast session is released, the UE's interest in multicast session changes, session is deactivated or activated) and de-prioritization/congestion status information is changed.

In an embodiment, the MBS multicast service controller (140) receives the RRC Release with the suspend configuration. Further, the MBS multicast service controller (140) receives the de-prioritization request for the multicast configuration. Further, the MBS multicast service controller (140) stores the de-prioritization request for the multicast configuration. Further, the MBS multicast service controller (140) starts the timer and maintains the de-prioritization request for the multicast configuration until the timer is expired or release of the de-prioritization request for the multicast configuration is received. Further, the MBS multicast service controller (140) performs the cell reselection in the RRC INACTIVE. Further, the MBS multicast service controller (140) considers a current frequency or frequency indicated in the stored de-prioritization request for the multicast configuration as a lowest priority.

The MBS multicast service controller (140) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (110) is configured to execute instructions stored in the memory (130) and to perform various processes. The communicator (120) is configured for communicating internally between internal hardware components and with external devices via one or more networks. The memory (130) also stores instructions to be executed by the processor (110). The memory (130) may include nonvolatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (130) may, in some examples, be considered a non-transitory storage medium. The term “non-transitory” may indicate that the storage medium is not embodied in a carrier wave or a propagated signal. However, the term “non-transitory” should not be interpreted that the memory (130) is non-movable. In certain examples, a non-transitory storage medium may store data that can, over time, change (e.g., in Random Access Memory (RAM) or cache).

Although the FIG. 2 shows various hardware components of the UE (100) but it is to be understood that other embodiments are not limited thereon. In other embodiments, the UE (100) may include less or more number of components. Further, the labels or names of the components are used only for illustrative purpose and does not limit the scope of the disclosure. One or more components may be combined together to perform same or substantially similar function in the UE (100).

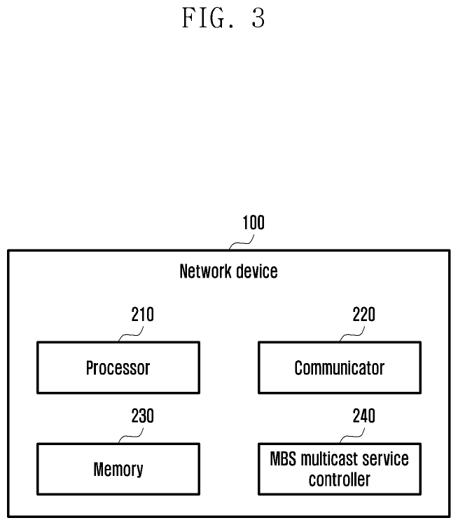

FIG. 3 shows various hardware components of the network device (200), according to the embodiments as disclosed herein. In an embodiment, the network device (200) includes a processor (210), a communicator (220), a memory (230) and a MBS multicast service controller (240). The processor (210) is coupled with the communicator (220), the memory (230) and the MBS multicast service controller (240).

The MBS multicast service controller (240) sends the message to support the mobility scenario of the UE (100) in the RRC inactive state to the UE (100). The message may be, for example, but not limited to the multicast service coverage information to support mobility of the UE (100), the multicast-include list for the cell reselection for the multicast service, the multicast-exclude list for the cell reselection for the multicast service, the list of neighbour cell information, the applicability information for multicast configuration of the serving cell for at least one neighbour cell, the neighbor cell multicast configuration, the cell status indication for the multicast reception, the cell reservation indication for the multicast reception, the cell reselection priority and the priority of the frequency for cell reselection. Further, the MBS multicast service controller (240) handles the multicast reception of the UE (100) based on the message.

The MBS multicast service controller (240) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (210) is configured to execute instructions stored in the memory (230) and to perform various processes. The communicator (220) is configured for communicating internally between internal hardware components and with external devices via one or more networks. The memory (230) also stores instructions to be executed by the processor (210). The memory (230) may include nonvolatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (230) may, in some examples, be considered a non-transitory storage medium. The term “non-transitory” may indicate that the storage medium is not embodied in a carrier wave or a propagated signal. However, the term “non-transitory” should not be interpreted that the memory (230) is non-movable. In certain examples, a non-transitory storage medium may store data that can, over time, change (e.g., in Random Access Memory (RAM) or cache).

Although the FIG. 3 shows various hardware components of the network device (200) but it is to be understood that other embodiments are not limited thereon. In other embodiments, the network device (200) may include less or more number of components. Further, the labels or names of the components are used only for illustrative purpose and does not limit the scope of the disclosure. One or more components may be combined together to perform same or substantially similar function in the network device (200).

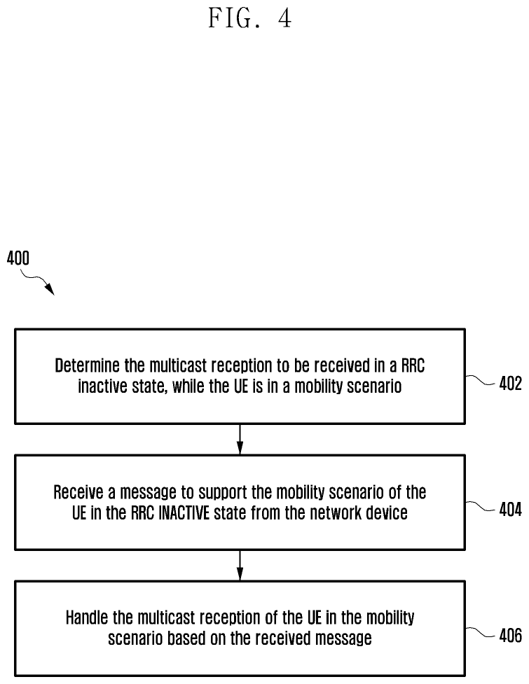

FIG. 4 is a flow chart (400) illustrating a method, implemented by the UE (100), for handling the multicast reception in the RRC inactive state in the wireless network (1000), according to the embodiments as disclosed herein. The operations (402-406) are handled by the MBS multicast service controller (140).

At step 402, the method includes determining the multicast reception to be received in the RRC inactive state, while the UE (100) is in the mobility scenario. At step 404, the method includes receiving the message to support the mobility scenario of the UE (100) in the RRC INACTIVE state from the network device (200). The message may be, for example, but not limited to the multicast service coverage information to support mobility of the UE (100), the multicast-include list for the cell reselection for the multicast service, the multicast-exclude list for the cell reselection for the multicast service, the list of neighbour cell information, the applicability information for multicast configuration of the serving cell for at least one neighbour cell, the neighbor cell multicast configuration, the cell status indication for the multicast reception, the cell reservation indication for the multicast reception, the cell reselection priority and a priority of the frequency for cell reselection. At step 406, the method includes handling the multicast reception of the UE (100) in the mobility scenario based on the received message.

In an embodiment, handling the multicast reception of the UE (100) based on the received includes stopping the cell reselection to the cell or the frequency that does not support the multicast session.

In another embodiment, handling the multicast reception of the UE (100) based on the received message includes performing at least one of: continuing to monitor the group paging or notification for activation of the multicast session and receiving the multicast session on a reselected cell, and determining a support of the multicast session and configuration of the multicast session on a reselected cell using neighbour cell information when the UE (100) performs reselection to the neighbour cell.

In another embodiment, handling the multicast reception of the UE (100) based on the received message includes indicating an interest to the network device (200) upon determining the UE (100) performs the cell reselection to the cell.

In another embodiment, handling the multicast reception of the UE (100) based on the received message includes reselecting the cell in the RNA, and continuing the multicast reception in the cell based on receiving the indication about all neighbour cells in the RNA or multicast coverage area comprising exactly same multicast MRB information, as that of serving cell, from the network device (200) over the message comprising the at least one neighbor cell multicast configuration.

In another embodiment, handling the multicast reception of the UE (100) based on the received message includes prioritizing the cell, and reselecting the cell in the RNA or multicast coverage area and continuing the multicast reception in the cell based on receiving an indication about the neighbour cell in the RNA comprising exactly same multicast MRB information, as that of serving cell, from the network device (200) over the message comprising at least one the neighbor cell multicast configuration.

In another embodiment, handling the multicast reception of the UE (100) based on the received message includes prioritizing the cell and reselecting the cell that provides the multicast service that the UE (100) is interested in, based on receiving an indication about all neighbour cells in the RNA comprising different multicast MRB information, as that of serving cell, from the network device (200) over the message comprising the at least one neighbor cell multicast configuration.

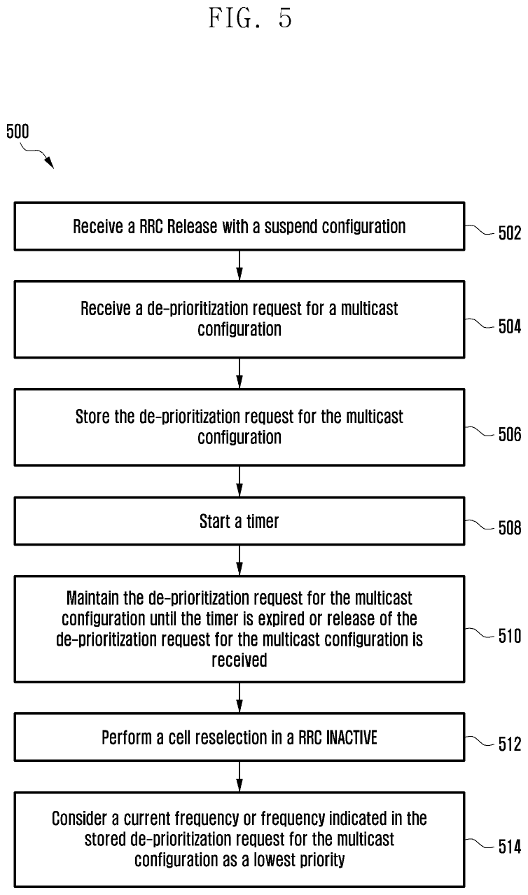

FIG. 5 is a flow chart (500) depicting a method, implemented by the UE (100), for enabling the UE (100) to perform cell reselection in the RRC inactive state, according to embodiments as disclosed herein. The operations (502-514) are handled by the MBS multicast service controller (140).

At step 502, the method includes receiving the RRC Release with the suspend configuration. At step 504, the method includes receiving the de-prioritization request for the multicast configuration. At step 506, the method includes storing the de-prioritization request for the multicast configuration. At step 508, the method includes starting the timer. At step 510, the method includes maintaining the de-prioritization request for the multicast configuration until the timer is expired or release of the de-prioritization request for the multicast configuration is received. At step 512, the method includes performing the cell reselection in the RRC INACTIVE. At step 514, the method includes considering the current frequency or frequency indicated in the stored de-prioritization request for the multicast configuration as the lowest priority.

In an example, upon the UE (100) receiving the RRC Release with the Suspend config and deprioritizationReqforMulticast configuration, the UE (100) stores deprioritizationReqforMulticast configuration and starts (an instance of) timer Txyz. The UE (100) maintains deprioritizationReqforMulticast configuration until (relevant instance of) expiry of timer Txyz and/or release of the relevant deprioritizationReqforMulticast configuration has been received. The UE (100) performs cell reselection in RRC_INACTIVE and considers the current frequency or frequencies indicated in the stored deprioritizationReqforMulticast configuration(s) as the lowest priority.

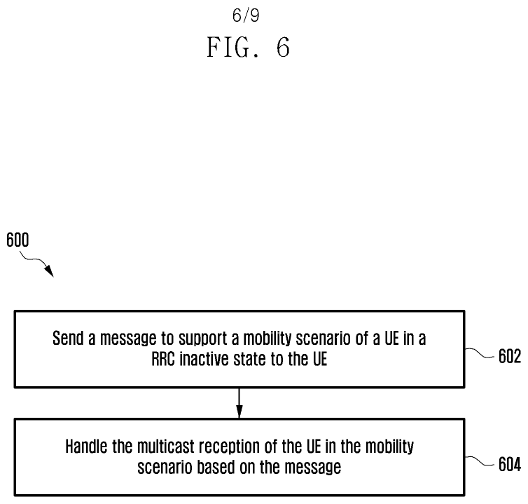

FIG. 6 is a flow chart (600) illustrating a method, implemented by the network device (200), for handling the multicast reception in the RRC inactive state in the wireless network (1000), according to the embodiments as disclosed herein. The operations (602-604) are handled by the MBS multicast service controller (240).

At step 602, the method includes sending the message to support the mobility scenario of the UE (100) in the RRC inactive state to the UE (100). At step 604, the method includes handling the multicast reception of the UE (100) in the mobility scenario based on the message.

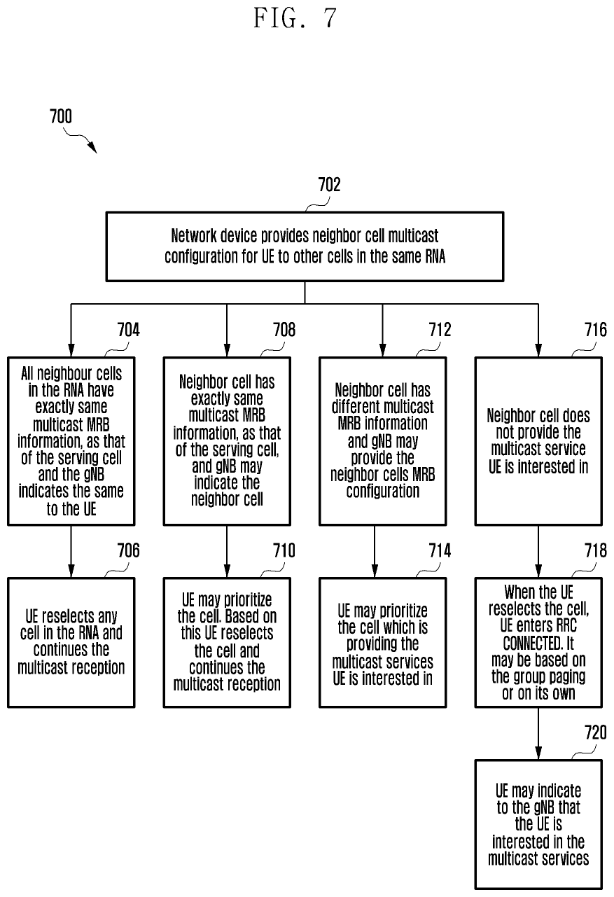

FIG. 7 is an example flow chart (700) illustrating a method for managing a mobility of UEs receiving the NR MBS multicast service in the RRC inactive state, according to embodiments as disclosed herein.

At step 702, the network device (200) provides the neighbor cell multicast configuration for the UE (100) to other cells in the same RNA. At step 704, all neighbour cells in the RNA have exactly same multicast MRB information, as that of the serving cell, and the network device (200) indicates the same to the UE (100). At step 706, the UE (100) reselects any cell in the RNA and continues the multicast reception.

At step 708, the neighbor cell has exactly same multicast MRB information, as that of the serving cell, and the gNB may indicate the neighbor cell. At step 710, the UE (100) may prioritize the cell. Based on this, the UE (100) reselects the cell and continues the multicast reception.

At step 712, the neighbor cell has different multicast MRB information and the gNB may provide the neighbor cells MRB configuration. At step 714, the UE (100) may prioritize the cell which is providing the multicast services UE (100) is interested in.

At step 716, the neighbor cell does not provide the multicast service UE is interested in. At step 718, when the UE (100) reselects the cell, the UE (100) enters the RRC connected. It may be based on the group paging or on its own. At step 720, the UE (100) may indicate to the gNB that the UE (100) is interested in the multicast services.

The method may be used to ensure the multicast service sustenance and continuity along with the mobility of the UEs in the RRC_INACTIVE state.

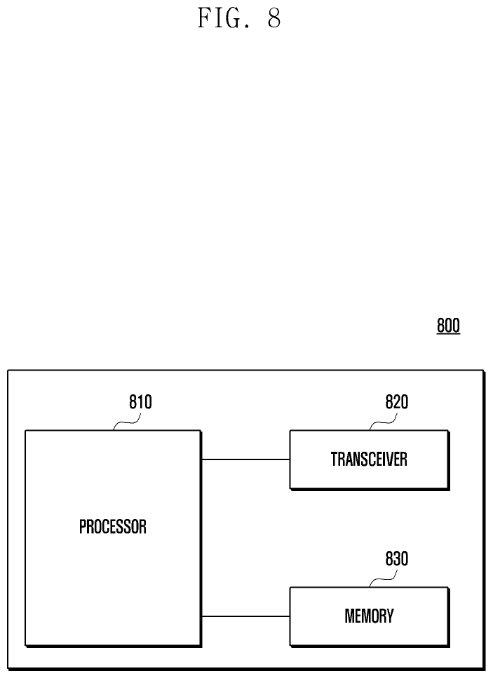

FIG. 8 illustrates an electronic device according to embodiments of the present disclosure.

Referring to the FIG. 8, the electronic device 800 may include a processor 810, a transceiver 820 and a memory 830. However, all of the illustrated components are not essential. The electronic device 800 may be implemented by more or less components than those illustrated in FIG. 8. In addition, the processor 810 and the transceiver 820 and the memory 830 may be implemented as a single chip according to another embodiment.

The electronic device 800 may correspond to the UE described above.

The aforementioned components will now be described in detail.

The processor 810 may include one or more processors or other processing devices that control the proposed function, process, and/or method. Operation of the electronic device 800 may be implemented by the processor 810.

The transceiver 820 may include a RF transmitter for up-converting and amplifying a transmitted signal, and a RF receiver for down-converting a frequency of a received signal. However, according to another embodiment, the transceiver 820 may be implemented by more or less components than those illustrated in components.

The transceiver 820 may be connected to the processor 810 and transmit and/or receive a signal. The signal may include control information and data. In addition, the transceiver 820 may receive the signal through a wireless channel and output the signal to the processor 810. The transceiver 820 may transmit a signal output from the processor 810 through the wireless channel.

The memory 830 may store the control information or the data included in a signal obtained by the electronic device 800. The memory 830 may be connected to the processor 810 and store at least one instruction or a protocol or a parameter for the proposed function, process, and/or method. The memory 830 may include read-only memory (ROM) and/or random access memory (RAM) and/or hard disk and/or CD-ROM and/or DVD and/or other storage devices.

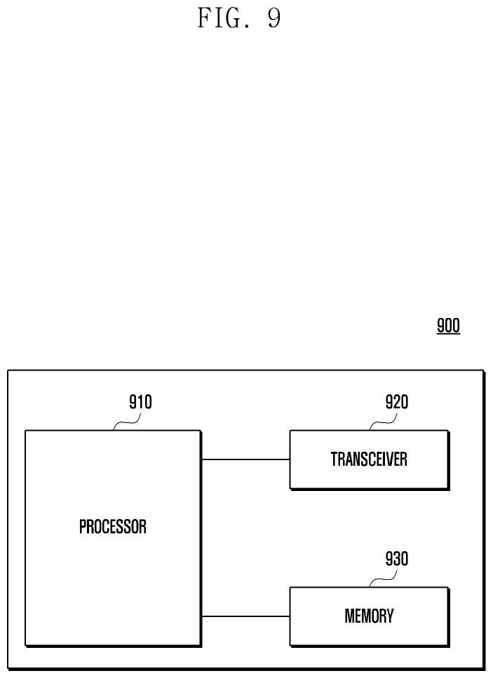

FIG. 9 illustrates a base station according to embodiments of the present disclosure.

Referring to the FIG. 9, the base station 900 may include a processor 910, a transceiver 920 and a memory 930. However, all of the illustrated components are not essential. The base station 900 may be implemented by more or less components than those illustrated in FIG. 9. In addition, the processor 910 and the transceiver 920 and the memory 930 may be implemented as a single chip according to another embodiment.

The base station 900 may correspond to the gNB or the network device described above.

The aforementioned components will now be described in detail.

The processor 910 may include one or more processors or other processing devices that control the proposed function, process, and/or method. Operation of the base station 900 may be implemented by the processor 910.

The transceiver 920 may include a RF transmitter for up-converting and amplifying a transmitted signal, and a RF receiver for down-converting a frequency of a received signal. However, according to another embodiment, the transceiver 920 may be implemented by more or less components than those illustrated in components.

The transceiver 920 may be connected to the processor 910 and transmit and/or receive a signal. The signal may include control information and data. In addition, the transceiver 920 may receive the signal through a wireless channel and output the signal to the processor 910. The transceiver 920 may transmit a signal output from the processor 910 through the wireless channel.

The memory 930 may store the control information or the data included in a signal obtained by the base station 900. The memory 930 may be connected to the processor 910 and store at least one instruction or a protocol or a parameter for the proposed function, process, and/or method. The memory 930 may include read-only memory (ROM) and/or random access memory (RAM) and/or hard disk and/or CD-ROM and/or DVD and/or other storage devices.

According to an embodiment, a method for handling multicast reception in a wireless network (1000) may be provided.

According to an embodiment, the method may include determining, by a user equipment (UE) (100), the multicast reception to be received in a radio resource control (RRC) inactive state, while the UE (100) is in a mobility scenario.

According to an embodiment, the method may include receiving, by the UE (100), at least one message to support the mobility scenario of the UE (100) in the RRC INACTIVE state from a network device (200).

According to an embodiment, the at least one message may include at least one of: a multicast service coverage information to support mobility of the UE (100), a multicast-include list for a cell reselection for the multicast service, a multicast-exclude list for the cell reselection for the multicast service, a list of neighbour cell information, an applicability information for multicast configuration of the serving cell for at least one neighbour cell, a neighbor cell multicast configuration, a cell status indication for the multicast reception, a cell reservation indication for the multicast reception, a cell reselection priority and a priority of the frequency for cell reselection.

According to an embodiment, the method may include handling, by the UE (100), the multicast reception of the UE (100) in the mobility scenario based on the at least one received message.

According to an embodiment, the at least one multicast service coverage information may include at least one of a list of neighbour cells to a serving cell and a frequency that support a multicast service.

According to an embodiment, the at least one multicast service coverage information may be provided through at least one of a RRC reconfiguration message carrying a MBS radio bearer (MRB) configuration for the multicast service, a RRC release with suspendconfig message carrying the MRB configuration for the multicast service reception, a system information block (SIB), and a MBS control channel (MCCH) signalling.

According to an embodiment, the UE (100) may not consider a cell in the multicast-exclude list as a candidate cell for the cell reselection, when the UE (100) is interested to receive the multicast service in the RRC inactive state, wherein the UE (100) considers at least one cell in the multicast-include list as a candidate cell for the cell reselection, when the UE (100) is interested to receive the multicast service in the RRC inactive state.

According to an embodiment, at least one of the cell status indication or the cell reservation indication may include at least one of a multicastCellBarred field, a multi-castCellBarred-inactive field, a multicastSupport field and a multicastSupport-inactive field.

According to an embodiment, at least one of the multicastCellBarred field or the multicastCellBarred-inactive field may indicate whether the cell is barred or not for the multicast reception in the RRC inactive state.

According to an embodiment, at least one of the multicastSupport field or the multi-castSupport-inactive field may indicate whether the multicast reception is supported or not in the RRC inactive state.

According to an embodiment, the cell status indication for the multicast reception, and the cell reservation indication for the multicast reception may be received in at least one of a MIB message, a SIB1 message, a MBS SIB message, and a MCCH message.

According to an embodiment, wherein handling, by the UE (100), the multicast reception of the UE (100) in the mobility scenario based on the at least one received message may include performing at least one of: reselecting a cell in a Radio Access Network based Notification Area (RNA) or a multicast coverage area, and continuing the multicast reception in the cell based on receiving an indication about all neighbour cells in the RNA or multicast coverage area comprising exactly same multicast MBS radio bearer (MRB) configuration information, as that of the serving cell, from the network device (200) over the at least one message comprising the at least one neighbor cell multicast configuration; prioritizing the cell, and reselecting the cell in the RNA or multicast coverage area and continuing the multicast reception in the cell based on receiving an indication about the neighbour cell in the RNA or the multicast coverage area comprising exactly same multicast MRB information, as that of the serving cell, from the network device (200) over the at least one message comprising the at least one neighbor cell multicast configuration; or prioritizing the cell, and reselecting the cell that provides the multicast service that the UE (100) is interested in, based on receiving an indication about all neighbour cells in the RNA or multicast coverage area comprising different multicast MRB information, as that of the serving cell, from the network device (200) over the at least one message comprising the at least one neighbor cell multicast configuration.

According to an embodiment, the UE (100) may consider a frequency providing or supporting a multicast communication to be a highest priority while performing the cell reselection when the UE (100) is configured to receive the multicast communication in the RRC INACTIVE state.

According to an embodiment, the UE (100) may perform a prioritization on at least one of the neighbour cell and a frequency for the cell reselection based on at least one of a strongest cell belonging to a highest reselection priority frequency, a rank of the cell, a signal strength of the cell, a support of the prioritized multicast session on the cell, and a state of the multicast session support on the cell for the UE (100), and a support for maximum number of relevant multicast sessions on the cell for the UE (100).

According to an embodiment, the UE (100) may re-derive a re-selection priority for a frequency by considering the multicast session supported by the cell, when the selected cell or frequency does not support the multicast session.

According to an embodiment, the UE (100) may determine a priority of the frequency for the cell reselection based on at least one of a broadcast signalling message, a dedicated signalling message, a cell reselection priority message and a multicast-cell reselection priority message received from a network device (200).

According to an embodiment, the UE (100) may derive reselection priorities for the cell reselection, while the UE (100) is configured to receive the at least one multicast session in the RRC inactive state based on at least one of: a frequency that supports the at least one multicast session have higher re-selection priority than another frequency that support none of the multicast session, the frequency determined based on a cell re-selection priority and a deprioritisation request for multicast, the frequency supporting the at least one multicast session prioritized based on a critical service.

According to an embodiment, the critical service may include at least one of a public safety service, mission critical push-to-talk (MCPTT) service.

According to an embodiment, wherein handling, by the UE (100), the multicast reception of the UE (100) in the mobility scenario based on the at least one received message may include: indicating an interest to the network device (200) upon determining the UE (100) performs the cell reselection to a cell, where the cell does not provide at least one activated multicast service in which the UE (100) is receiving, wherein the indication is provided at least one of a MBS interest indication message, a UE assistance information message, a short message and a pre-configured random access preamble, wherein the interest is indicated to the network device (200) after the UE (100) transits to a RRC connected state from the RRC inactive state.

According to an embodiment, wherein handling, by the UE (100), the multicast reception of the UE (100) in the mobility scenario based on the at least one received message may include: performing at least one of: continuing to monitor a group paging or notification for activation or deactivation of at least one multicast session and receiving at least one multicast session on a reselected cell, and determining a support of the multicast session and configuration of the multicast session on a reselected cell using neighbour cell information when the UE (100) performs reselection to a neighbour cell.

According to an embodiment, wherein handling, by the UE (100), the multicast reception of the UE (100) in the mobility scenario based on the at least one received message may include at least one of: stopping or deprioritizing a cell reselection to a cell or a frequency that does not support the at least one multicast session that the UE (100) is interested in; and transiting to RRC connected state when a cell reselection to a cell or a frequency does not support the at least one multicast session that the UE (100) is interested in.

According to an embodiment, wherein the cell reselection for the UE (100) interested to receive the multicast in the RRC INACTIVE state may be triggered when at least one of a performance trigger condition is met, a broadcasted signaling for a cell reselection is changed, a multicast session is changed, a MRB information is changed, a de-prioritization is changed, and a congestion status information is changed.

According to an embodiment, a method for handling multicast reception in a wireless network (1000) may be provided.

According to an embodiment, the method may include receiving, by a UE (100), a radio resource control (RRC) release with a suspend configuration.

According to an embodiment, the method may include receiving, by the UE (100), a de-prioritization request for a multicast configuration.

According to an embodiment, the method may include storing, by the UE (100), the de-prioritization request for the multicast configuration.

According to an embodiment, the method may include starting, by the UE (100), a timer.

According to an embodiment, the method may include maintaining, by the UE (100), the de-prioritization request for the multicast configuration until the timer is expired or release of the de-prioritization request for the multicast configuration is received.

According to an embodiment, the method may include performing, by the UE (100), a cell reselection in a RRC INACTIVE.

According to an embodiment, the method may include considering, by the UE (100), a current frequency or frequency indicated in the stored de-prioritization request for the multicast configuration as a lowest priority.

According to an embodiment, a method for handling multicast reception in a wireless network (1000) may be provided.

According to an embodiment, the method may include sending, by a network device (200), at least one message to support a mobility scenario of a user equipment (UE) (100) in a RRC inactive state to the UE (100).

According to an embodiment, the at least one message may include at least one of: a multicast service coverage information to support mobility of the UE (100), a multicast-include list for a cell reselection for the multicast service, a multicast-exclude list for the cell reselection for the multicast service, a list of neighbour cell information, an applicability information for multicast configuration of the serving cell for at least one neighbour cell, a neighbor cell multicast configuration, a cell status indication for the multicast reception, a cell reservation indication for the multicast reception, a cell reselection priority and a priority of the frequency for cell reselection.

According to an embodiment, the method may include handling, by the network device (200), the multicast reception of the UE (100) in the mobility scenario based on the at least one message.

According to an embodiment, the at least one multicast service coverage information may include at least one of a list of neighbour cells to a serving cell and a frequency that support a multicast service.

According to an embodiment, the at least one multicast service coverage information may be provided through at least one of a RRC reconfiguration message carrying a MBS radio bearer (MRB) configuration for the multicast service, a RRC Release with suspendconfig message carrying the MRB configuration for the multicast service reception, a system information block (SIB), and a MBS control channel (MCCH) signalling.

According to an embodiment, at least one of the cell status indication or the cell reservation indication may include at least one of a multicastCellBarred field, a multi-castCellBarred-inactive field, a multicastSupport field and a multicastSupport-inactive field, wherein at least one of the multicastCellBarred field and the multicastCellBarred-inactive field indicates whether the cell is barred or not for the multicast reception in the RRC inactive state.

According to an embodiment, at least one of the multicastSupport field or the multi-castSupport-inactive field may indicate whether the multicast reception is supported or not in the RRC inactive state.

According to an embodiment, the cell status indication for the multicast reception, and the cell reservation indication for the multicast reception may be received in at least one of a MIB message, a SIB1 message, an MBS SIB message, and a MCCH message.

According to an embodiment, a user equipment (UE) (100) may be provided.

According to an embodiment, the UE (100) may include a processor (110); a memory (130); and an MBS multicast service controller (140), coupled with the processor (110) and the memory (130).

According to an embodiment, the MBS multicast service controller (140) may be configured to determine the multicast reception to be received in a radio resource control (RRC) inactive state, while the UE (100) is in a mobility scenario.

According to an embodiment, the MBS multicast service controller (140) may be configured to receive at least one message to support the mobility scenario of the UE (100) in the RRC INACTIVE state from a network device (200).

According to an embodiment, the at least one message may include at least one of: a multicast service coverage information to support mobility of the UE (100), a multicast-include list for a cell reselection for the multicast service, a multicast-exclude list for the cell reselection for the multicast service, a list of neighbour cell information, an applicability information for multicast configuration for neighbour cell, a neighbor cell multicast configuration, a cell status indication for the multicast reception, a cell reservation indication for the multicast reception, a cell reselection priority or a priority of the frequency for cell reselection.

According to an embodiment, the MBS multicast service controller (140) may be configured to handle the multicast reception of the UE (100) based on the at least one received message.

According to an embodiment, a user equipment (UE) (100) may be provided.

According to an embodiment, the UE (100) may include a processor (110); a memory (130); and an MBS multicast service controller (140), coupled with the processor (110) and the memory (130).

According to an embodiment, the MBS multicast service controller (140) may be configured to configured to receive a radio resource control (RRC) release with a suspend configuration.

According to an embodiment, the MBS multicast service controller (140) may be configured to receive a de-prioritization request for a multicast configuration.

According to an embodiment, the MBS multicast service controller (140) may be configured to store the de-prioritization request for the multicast configuration.

According to an embodiment, the MBS multicast service controller (140) may be configured to start a timer.

According to an embodiment, the MBS multicast service controller (140) may be configured to maintain the de-prioritization request for the multicast configuration until the timer is expired or release of the de-prioritization request for the multicast configuration is received.

According to an embodiment, the MBS multicast service controller (140) may be configured to perform a cell reselection in a RRC INACTIVE.

According to an embodiment, the MBS multicast service controller (140) may be configured to consider a current frequency or frequency indicated in the stored de-prioritization request for the multicast configuration as a lowest priority.

According to an embodiment, a network device (200) may be provided.

According to an embodiment, the network device (200) may include a processor (210); a memory (230); and an MBS multicast service controller (240), coupled with the processor (210) and the memory (230).

According to an embodiment, the MBS multicast service controller (240) may be configured to send at least one message to support a mobility scenario of a user equipment (UE) (100) in a RRC inactive state to the UE (100).

According to an embodiment, the at least one message may include at least one of: a multicast service coverage information to support mobility of the UE (100), a multicast-include list for a cell reselection for the multicast service, a multicast-exclude list for the cell reselection for the multicast service, a list of neighbour cell information, an applicability information for multicast configuration of the serving cell for at least one neighbour cell, a neighbor cell multicast configuration, a cell status indication for the multicast reception, a cell reservation indication for the multicast reception, a cell reselection priority or a priority of the frequency for cell reselection.

According to an embodiment, the MBS multicast service controller (240) may be configured to handle the multicast reception of the UE (100) based on the at least one message.

The various actions, acts, blocks, steps, or the like in the flow charts (400 and 700) may be performed in the order presented, in a different order or simultaneously. Further, in some embodiments, some of the actions, acts, blocks, steps, or the like may be omitted, added, modified, skipped, or the like without departing from the scope of the disclosure.

The embodiments disclosed herein may be implemented through at least one software program running on at least one hardware device and performing network management functions to control the elements. The elements may be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of at least one embodiment, those skilled in the art will recognize that the embodiments herein may be practiced with modification within the spirit and scope of the embodiments as described herein.

1. A method performed by a user equipment (UE) in a communication system, the method comprising:
receiving a radio resource control (RRC) release message including suspend configuration information and frequency information associated with cell reselection;
performing, in an RRC inactive state, the cell reselection based on the frequency information, wherein the UE is configured to receive data associated with multicast broadcast service (MBS) multicast in the RRC inactive state; and
receiving the data associated with MBS multicast in the RRC inactive state or in an RRC connected state,
wherein, in case that configuration information associated with the MBS multicast is unavailable in the reselected cell, the data associated with MBS multicast is received in the RRC connected state, and
wherein, in case that the configuration information is available in the reselected cell, the data associated with MBS multicast is received in the RRC inactive state.

2-15. (canceled)

16. The method of claim 1, wherein the configuration associated with the MBS multicast includes multicast MBS radio bearer (MRB) information.

17. The method of claim 1, further comprising receiving, on an MBS control channel (MCCH), information on a list of neighbor cells supporting a same MBS multicast service for the RRC inactive state.

18. The method of claim 17,
wherein, in case that the MBS multicast is unavailable in the reselected cell identified based on the information, the data associated with MBS multicast is received in the RRC connected state, and
wherein, in case that the MBS multicast is available in the reselected cell identified based on the information, the data associated with MBS multicast is received from the reselected cell in the RRC inactive state.

19. The method of claim 1, wherein receiving the data associated with MBS multicast comprises continuing receiving the data associated with MBS multicast in the RRC inactive state or in the RRC connected state.

20. A user equipment (UE) in a communication system, the UE comprising:
a transceiver; and
a processor coupled with the transceiver and configured to:
receive a radio resource control (RRC) release message including suspend configuration information and frequency information associated with cell reselection;
perform, in an RRC inactive state, the cell reselection based on the frequency information, wherein the UE is configured to receive data associated with multicast broadcast service (MBS) multicast in the RRC inactive state; and
receive the data associated with MBS multicast in the RRC inactive state or in an RRC connected state,
wherein, in case that configuration information associated with the MBS multicast is unavailable in the reselected cell, the data associated with MBS multicast is received in the RRC connected state, and
wherein, in case that the configuration information is available in the reselected cell, the data associated with MBS multicast is received in the RRC inactive state.

21. The UE of claim 20, wherein the configuration associated with the MBS multicast includes multicast MBS radio bearer (MRB) information.

22. The UE of claim 20, wherein the processor is further configured to receive, on an MBS control channel (MCCH), information on a list of neighbor cells supporting a same MBS multicast service for the RRC inactive state.

23. The UE of claim 22,
wherein, in case that the MBS multicast is unavailable in the reselected cell identified based on the information, the data associated with MBS multicast is received in the RRC connected state, and
wherein, in case that the MBS multicast is available in the reselected cell identified based on the information, the data associated with MBS multicast is received from the reselected cell in the RRC inactive state.

24. The UE of claim 22, wherein the processor is further configured to continue receiving the data associated with MBS multicast in the RRC inactive state or in the RRC connected state.

25. A method performed by a base station in a communication system, the method comprising:
identifying that a user equipment (UE) is configured to receive data associated with multicast broadcast service (MBS) multicast in a radio resource control (RRC) inactive state;
transmitting, to the UE, an RRC release message including suspend configuration information and frequency information associated with cell reselection; and
transmitting, to the UE in the RRC inactive state or an RRC connected state, the data associated with MBS multicast,
wherein, in case that configuration information associated with the MBS multicast is unavailable in a cell associated with the cell reselection, the data associated with MBS multicast is transmitted to the UE in the RRC connected state, and
wherein, in case that the configuration information is available the cell associated with the cell reselection, the data associated with MBS multicast is transmitted to the UE in the RRC inactive state.

26. The method of claim 25, wherein the configuration associated with the MBS multicast includes multicast MBS radio bearer (MRB) information.

27. The method of claim 25, further comprising transmitting, on an MBS control channel (MCCH), information on a list of neighbor cells supporting a same MBS multicast service for the RRC inactive state.

28. The method of claim 27,
wherein, in case that the MBS multicast is unavailable in the reselected cell indicated based on the information, the data associated with MBS multicast is transmitted to the UE in the RRC connected state, and
wherein, in case that the MBS multicast is available in the reselected cell indicated based on the information, the data associated with MBS multicast is transmitted to the UE in the RRC inactive state on the cell associated with the cell reselection.

29. The method of claim 25, wherein transmitting the data associated with MBS multicast comprises continuing transmitting the data associated with MBS multicast to the UE in the RRC inactive state or in the RRC connected state.

30. A base station in a communication system, the base station comprising:
a transceiver; and
a processor coupled with the transceiver and configured to:
identify that a user equipment (UE) is configured to receive data associated with multicast broadcast service (MBS) multicast in a radio resource control (RRC) inactive state;
transmit, to the UE, an RRC release message including suspend configuration information and frequency information associated with cell reselection; and
transmit, to the UE in the RRC inactive state or an RRC connected state, the data associated with MBS multicast,
wherein, in case that configuration information associated with the MBS multicast is unavailable in a cell associated with the cell reselection, the data associated with MBS multicast is transmitted to the UE in the RRC connected state, and
wherein, in case that the configuration information is available the cell associated with the cell reselection, the data associated with MBS multicast is transmitted to the UE in the RRC inactive state.

31. The base station of claim 30, wherein the configuration associated with the MBS multicast includes multicast MBS radio bearer (MRB) information.

32. The base station of claim 30, wherein the processor is further configured to transmit, on an MBS control channel (MCCH), information on a list of neighbor cells supporting a same MBS multicast service for the RRC inactive state.

33. The base station of claim 32,
wherein, in case that the MBS multicast is unavailable in the reselected cell indicated based on the information, the data associated with MBS multicast is transmitted to the UE in the RRC connected state, and
wherein, in case that the MBS multicast is available in the reselected cell indicated based on the information, the data associated with MBS multicast is transmitted to the UE in the RRC inactive state on the cell associated with the cell reselection.

34. The base station of claim 30, wherein the processor is further configured to continue transmitting the data associated with MBS multicast to the UE in the RRC inactive state or in the RRC connected state.
